(19) United States
(12) Patent Application Publication
(10) Pub. No.: US 2010/0270899 A1
(43) Pub. Date: Oct. 28, 2010

(54) Sorting Installation

(76) Inventor: Wolfgang E. Perner, Gmunden (AT)

Correspondence Address: DILWORTH & BARRESE, LLP, 1000 WOODBURY ROAD, SUITE 405, WOODBURY, NY, 11797, US

(21) Appl. No.: 12/224,071

(22) PCT Filed: Feb. 15, 2006
(86) PCT No.: PCT/EP2006/001372

§ 371 Date: Jun. 11, 2010

(51) Int. Cl. B07C 7/02; A47B 88/20; A47B 88/12

(52) U.S. Cl. 312/334.1; 312/348.3

(57) ABSTRACT

A sorting installation (10) for sorting items has a holder (12) which is open at the front, having at least one sorting compartment (14) for accommodating sorted items and at least one partition element for subdividing the sorting compartment. At least one sorting compartment has a drawer (18) which can be pulled out of the holder at least partially in a pulling-out direction, and with at least one partition element configured as a separator (20, 21, 22), arranged parallel to the pulling-out direction, not fixed to the drawer and, when the drawer is moved out in the pulling-out direction, not moving along therewith; once moved out, the drawer is no longer subdivided by the least one separator.

The present invention relates to a sorting installation for the sorting of articles to be sorted, in particular items of mail, having a holder open to the front, at least one sorting compartment in the holder for the reception of sorted articles and at least one dividing member for the division of the sorting compartment into sub-compartments.

Sorting installations are in particular used for the sorting of items of mail. Known installations, for example, include a shelf-like carcass with shelf compartment-like horizontal divisions which form sorting compartments. The individual sorting compartments are divided by fixed dividing walls so that individual sub-compartments open to the front are formed.

Individual delivery areas are associated with the individual sub-compartments for the case of mail sorting, for example. The user sorts the mail present in non-ordered form into the sub-compartments by delivery area. After complete sorting, he takes the items of mail out of the respective sub-compartments and places them, for example, into his mailbag or into another transport unit in the order of the delivery areas. The mail is already sorted in this manner and can be taken out of the transport unit and delivered in the order of the delivery areas.

The size of the individual sub-compartments is fixedly preset by the fixed dividing members. The amount of mail for different delivery areas is, however, different as a rule so that it can occur

that the amount of mail of a delivery area does not fit into the sub-compartment provided for it.

When the mail is taken out of the individual sub-compartments and is placed into the transport unit or mailbag, the user must empty every single compartment and place the items of mail contained therein into the bag or transport unit. Each sub-compartment therefore requires an individual access step.

It is the object of the present invention to provide a sorting installation which enables a simple and time-saving sorting. This object is satisfied by a sorting installation having the features of claim 1. Dependent claims are directed to preferred embodiments.

With the sorting installation in accordance with the invention, at least one sorting compartment has a pull-out drawer which can be pulled out of the holder at least partly on telescopic rails, for example. A corresponding abutment can be provided for the bounding of the pulling-out so that the pull-out drawer cannot fall down on being pulled out.

The sorting installation in accordance with the invention has at least one sorting compartment having a pull-out drawer which is preferably open to the front. If a plurality of sorting compartments are provided, they all advantageously have a pull-out drawer designed In accordance with the invention. Embodiments are, however, also possible in which individual sorting compartments do not have any pull-out drawer and are in this respect not designed in accordance with the invention. If not otherwise stated, the term “sorting compartment” is to be understood in the following as a sorting compartment with a pull-out drawer designed in accordance with the invention.

At least one dividing member, which is provided for the division of the sorting compartment with a pull-out drawer, is designed as a separator which is arranged parallel to the pulling-out direction of the pull-out drawer, which is not fixedly connected to the pull-out drawer and which does not move along on the moving out of the pull-out drawer in the pulling-out direction so that the pull-out drawer is no longer divided by the at least one separator after having been moved out. Whereas therefore the pull-out drawer forming the sorting compartment is divided into individual sub-compartments by the separators in the non pulled-out state, the separators do not move along on the pulling out of the pull-out drawer so that the division is cancelled during the process of pulling out the pull-out drawer. In the pulled-out state, the pull-out drawer forming the sorting compartment is therefore no longer divided.

The function will be explained with reference to the sorting of items of mail. The user sorts the items of mail into the pull-out drawer divided by the separators as long as it is divided by separators. For example, the individual sub-compartments formed by the separators can be associated with individual mail delivery areas. After a complete sorting of the mail amount, the user pulls the pull-out drawer out to the front. The separators do not move along with this pull-out movement so that the division into sub-compartments is cancelled. The items of mail are nevertheless located in the pull-out drawer ordered by delivery area. The items of mail can now be pushed together by the user in a lateral direction and be removed from the pull-out drawer in one single work step and placed into the mailbag or transport unit.

The removal of the articles to be sorted from the pull-out drawer is therefore a lot less time intensive than if a larger number of individual compartments had to be emptied.

The invention is in particular suitable for the sorting of items of mail by delivery areas of a mailman, for example The invention can, however, advantageously be used in all sorting processes in which articles to be sorted have to be put into divisions and subsequently have to be further processed in the order of this division.

The invention proves to be particularly effective when a plurality of separators designed in accordance with the invention are provided in a sorting compartment.

It is particularly advantageous for the pull-out drawer no longer to have any division at all in the pulled out state and to correspond to a pull-out drawer of a sorting compartment in this respect. Designs are, however, also possible in which two or more sorting compartments are provided per pull-out drawer, with the individual sorting compartments in turn being divided by the separators in the non pulled-out state of the pull-out drawer, but with no more division being present after the pulling out. It can thus be advantageous for stability reasons, for example, for a pull-out drawer to have a fixed center wall at its center so that a pull-out drawer includes two sorting compartments to the right and left of the center wall. Such a division of a pull-out drawer into a plurality of sorting compartments can also be sensible with very large pull-out drawers, for example, in which, after pulling out the pull-out drawer and in this respect cancelling the division into sub-compartments, too large a non-divided compartment would result whose content would be difficult to handle on being pulled out.

Such a center wall, which, unlike the separators, moves along with the pulling-out movement of the pull-out drawer, can also be made displaceable. It can, for example, be fixedly screwed to different positions of the pull-out drawer as required. The total size of a sorting compartment can thus be adjusted to correspond to the typical volume of a mailbag. A plurality of center walls fixedly anchored or anchorable in the pull-out drawer can also be provided.

So that the separators do not move along on the pulling-out process of the pull-out drawer, guides or openings are advantageously located in the rear wall side of the pullout drawer through which the separators can slide when the pull-out drawer is pulled out. In a particularly preferred aspect, the rear wall of the pull-out drawer has slots, with the individual slots being designed such that a separator can slide through them. The number of guides or slots corresponds in this respect at least to the number of desired separators. An aspect is particularly flexible in which a larger number of guides or slots is provided at predetermined intervals so that the number and the spacing of the individual separator can be selected by selection of the guides or slots used.

In a further development of this aspect, the guides or slots are dimensioned such that they guide the separators. For this purpose, the lateral extent of the guides or slots can in particular be selected such that it substantially corresponds to the thickness of the individual separators without, however, clamping them.

The guides or slots in the rear wall of the pull-out drawer define the spatial extent of the separators. A vertical alignment of the separators, that is a vertical alignment of the slots or guides, is particularly economical in terms of space. Aspects are, however, also possible, in which the guides or slots, and thus the separators, are aligned obliquely.

The slots in the rear wall of the pull-out drawer can, in an advantageous further development, have guide stubs which are provided, for example, outwardly at the rear wall of the pull-out drawer and support the lateral support of the separators, in particular when the pull-out drawer is pulled out. Such guide stubs additionally serve for the stabilization of the slotted rear wall. They can be designed such that they increase the effective thickness of the rear wall when the rear wall is thin-walled, for example.

The separators are particularly preferably made such that they can be removed from the sorting installation. In this manner, a user can insert the separators in different numbers and at different intervals as required and depending on the demands.

To ensure that the separators do not move along with the pulling-out process of the pull-out drawer, the separators are connected to the holder or to an element fixedly connected to the holder. In the case of releasable separators, this connection is also made releasable. It can, for example, be a question of latch elements, magnetic connections or articulated connections. An embodiment is particularly preferred in which the at least one separator has a hook which is arranged at the rear in the pulling-out direction of the pull-out drawer and which cooperates with a holding edge or holding rod which is fixedly connected to the holder, with the holding edge or holding rod being aligned parallel to the rear wall of the pull-out drawer and being arranged at a level which corresponds to the vertical position of the hook of a separator in its inserted state. If the hook is hooked to the holding rod or to the holding edge, the separator cannot move in the pulling-out direction. If the pull-out drawer is pulled out, the hook holds the separator at the holding rod or at the holding edge such that the pull-out drawer moves without the separator and the separator loses its dividing function. The holding edge or the holding rod is preferably aligned horizontally and the opening of the hook of the separator faces downwardly. The hooking of the hook to the holding edge or to the holding rod is then effected or supported by the gravity of the separator.

The term “hook” should here generally designate elements which have a cut-out to engage around the holding rod or the holding edge.

A particularly preferred further development of this embodiment is characterized in that the hook is chamfered or rounded at its outer side and/or the holding rod or the holding edge is chamfered or rounded at the side facing the pull-out drawer. When the separator and the holding rod or holding edge move relative to one another, in such an aspect the hook slides off at the holding edge or holding rod until its hook opening can engage around the holding rod or holding edge. In particular with an embodiment in which the hook opening faces downwardly, the separator then falls downwardly such that the hook hooks in at the holding edge or holding rod.

The following procedure can, for example, be followed with such an advantageous embodiment. In the pulled-out state of the pull-out drawer, the separators can be inserted into the pull-out drawer, for example in a desired number and at a desired interval. They are, for example, held by the guides or slots at the rear region of the pull-out drawer. The pull-out drawer is now pushed into the holder together with the separators. At the end of the push-in process, the hooks of the separators are incident onto the holding rod or holding edge and move upwardly at least in the rear region of the separators due to the chamfer. If the pull-out drawer is pushed in further, the hooks can engage around the holding rod or the holding edge such that the raised separators fall downwardly and the hooks come into engagement with the holding rod or the holding edge. The separators are thus firmly fixed in the pulling-out direction and can no longer move along with the pull-out drawer. The articles to be sorted can be sorted into the sub-compartments of the pull-out drawer bounded by the separators. A moving out of the pull-out drawer after the sorting of the articles to be sorted takes place without moving the hooked-in separators so that they lose their separating function.

To support the separators, in particular to hold them in their spatial orientation, while the pull-out drawer is being pulled out, a support stationary with respect to the holder of the sorting installation can be provided into which the separators are inserted during the pulling-out process of the pull-out drawer. It is preferably a support in which slot-like support mounts for the separators are provided. For example, the support can be provided in the region of the holding rod or of the holding edge of the corresponding embodiment and the slots can be aligned in a direction which corresponds to the desired spatial direction of the separators.

A preferred further development of this aspect provides that the support has an adjustment mechanism which is designed to adjust the support mounts for the separators. Depending on the design, the adjustment mechanism can serve for the adjustment of the angular alignment of the slots of the support parallel to the slots in the rear wall of the pull-out drawer and/or for the exact setting of the slot position of the support with respect to the slots of the rear wall of the pull-out drawer.

For this purpose, an adjustment screw can, for example, be provided with which the totality of the slots of the support can be displaced by some millimeters with respect to the holder. In a further development which is simple to handle, the adjustment screw is accessible from the side, for example, by a bore in the side wall of a carcass-like holder.

It is particularly preferred for the individual separators in the pull-out drawer not to be held only by the guides or slots in the rear wall region of the pull-out drawer in the sorting process so that the separators are held tight in multiple manner during the sorting process. For this purpose, a projection can in particular be provided at each separator which engages into a corresponding projection mount in the pull-out drawer when the pull-out drawer is pushed in and which is released on the pulling out of the pull-out drawer from the projection mount.

In the inserted state of the pull-out drawer, the separators are in this manner not only supported by the guides or slots in the rear region of the pull-out drawer and the optionally present support, but additionally by the projections engaging into the projection mounts. It is thus in particular ensured that the separators also do not change their position when one of the sub-compartments formed by the division of the separators is overfilled

For this purpose, the projection is particularly advantageously provided in the region of the separator at its lower edge and at the front in the pulling-out direction of the pull-out drawer, with the projection mounts being arranged accordingly in the base of the pull-out drawer in its region at the front in the pulling-out direction.

To ensure a hindrance-free sliding of the projection of the at least one separator out of the corresponding projection mount, provision is made in an advantageous further development for the projection and/or the projection mount to be chamfered such that they slide off one another on the pulling out of the pull-out drawer. The rearwardly facing edge of the projection, which is provided in the front region of a separator at its lower edge, can, for example, in particular be correspondingly chamfered or rounded.

If the at least one separator should be held both by the projection received in the projection mount and by the guides or slots in the rear side of the pull-out drawer, the spacing of the projection of a separator from the edge of the separator at the rear in the pulling-out direction of the pull-out drawer is larger than the spacing of the projection mount from the rear wall of the pull-out drawer. It is ensured in this manner that in the pushed-in state of the pull-out drawer, when the projection of the at least one separator engages into the projection mount, the separator engages in the rear region into a guide or into a slot in the rear side of the pull-out drawer. The separator is securely supported at least two points in this manner.

The separators can be used as follows with such a design: The pull-out drawer is first pulled out. The separators are inserted at the desired interval and in the desired number with their respective projections into the projection mounts of the pull-out drawer and are plugged into the guides or slots in the rear side of the pull-out drawer. The pull-out drawer with the separators fixed in this manner is pushed back into the holder.

The separators can be made differently, for example as grid-like structures. Plates of metal or plastic are particularly simple and are comfortable in application.

The at least one separator can be shaped from different materials, for example from metal or plastic. A separator can be manufactured particularly simply and cost-effectively as an injection molded plastic part. A separator of plastic additionally has sufficient flexibility to have a specific tolerance with respect to overfilling of the sub-compartments formed by the separators.

The invention will be explained in detail with reference to the enclosed Figures. The Figures shows embodiments in accordance with the invention for the sorting of items of mail. There are shown:

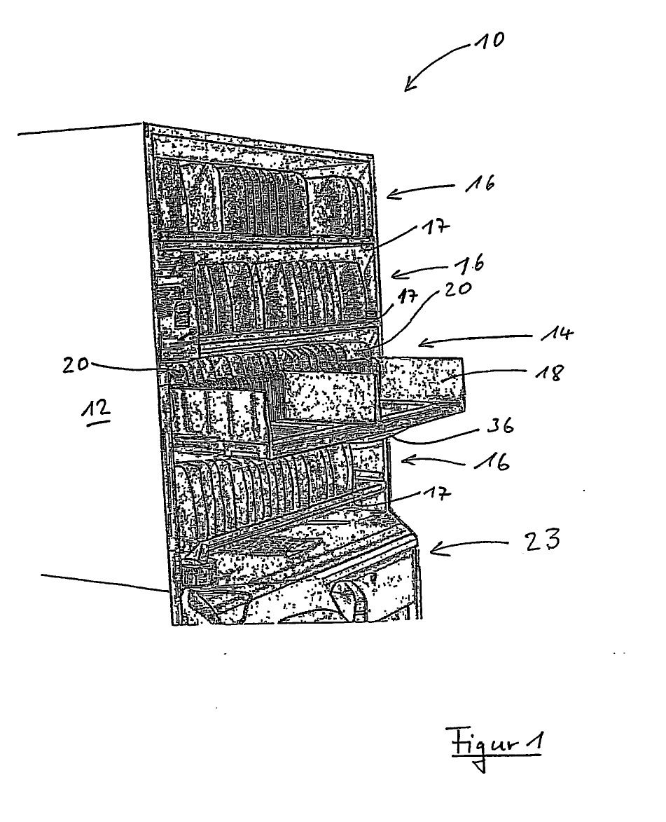

FIG. 1 a perspective view of the front side of an embodiment of a mail sorting application in accordance with the invention;

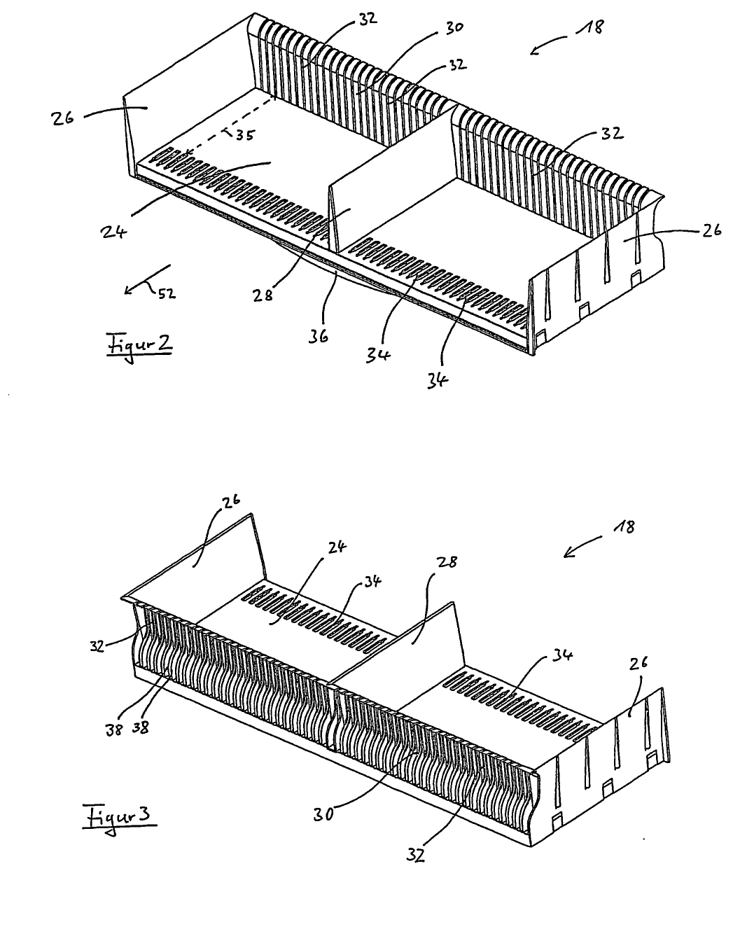

FIG. 2 a pull-out drawer of an embodiment in accordance with the invention obliquely from the front;

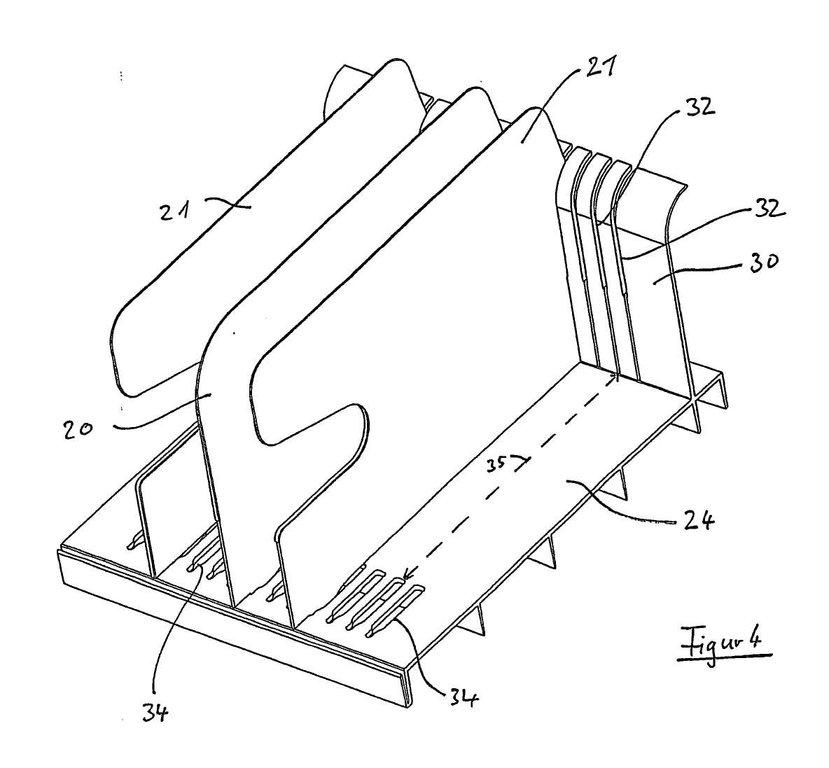

FIG. 3 the pull-out drawer of FIG. 2 obliquely from the rear;

FIG. 4 a detail of the pull-out drawer with differently inserted separators;

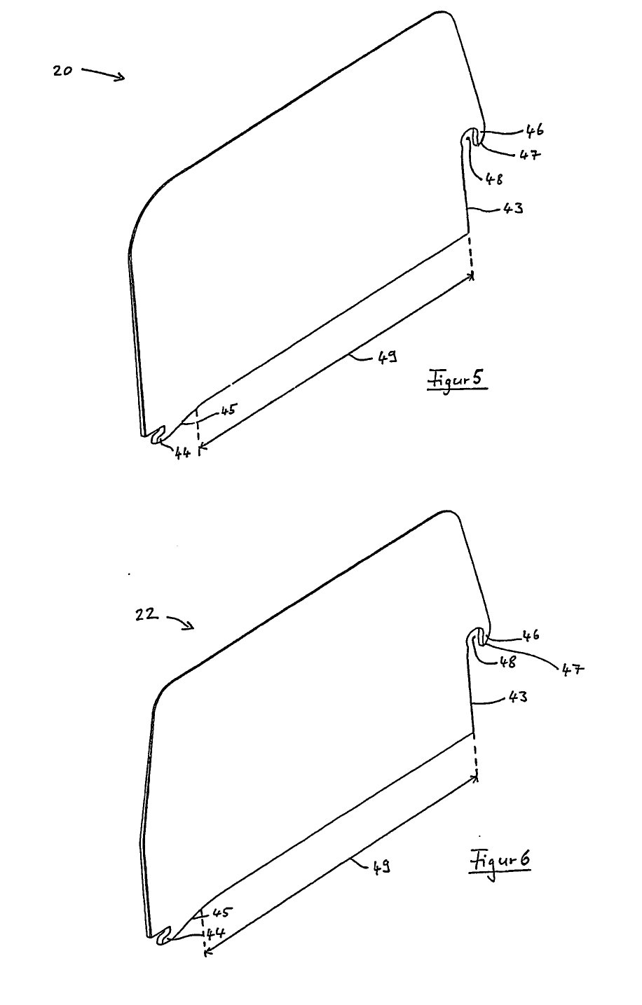

FIG. 5 a separator of an embodiment in accordance with the invention;

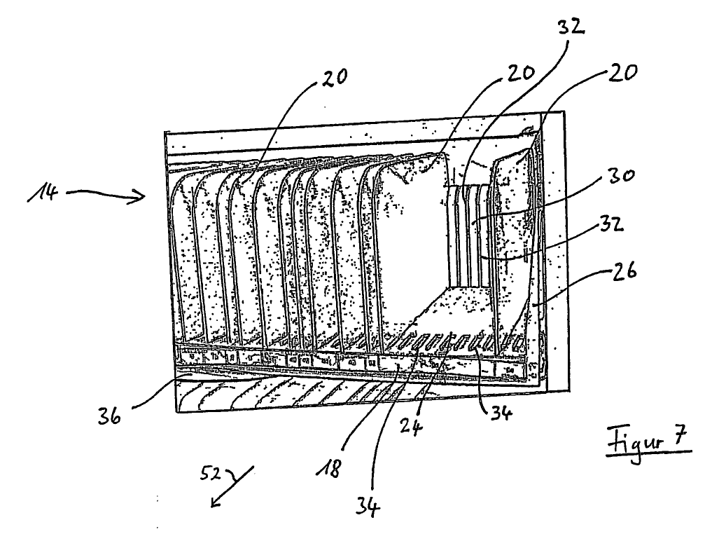

FIG. 6 a different aspect of a separator of an embodiment in accordance with the invention;

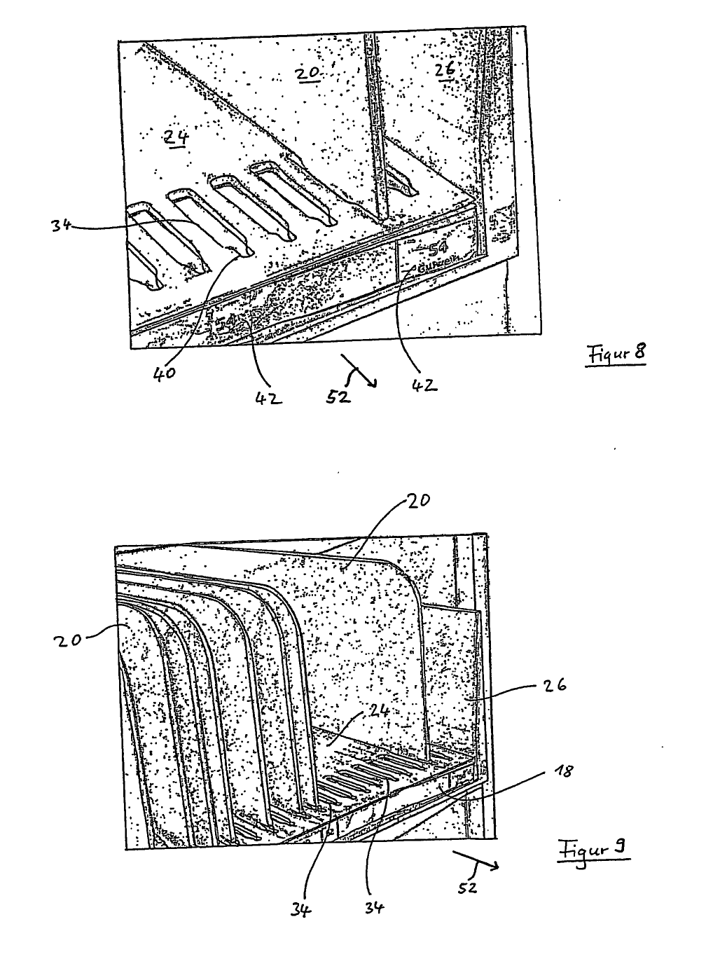

FIG. 7 a plan view from the front of a sorting compartment of an embodiment in accordance with the invention;

FIG. 8 an enlargement of a detail of the embodiment shown in FIG. 7;

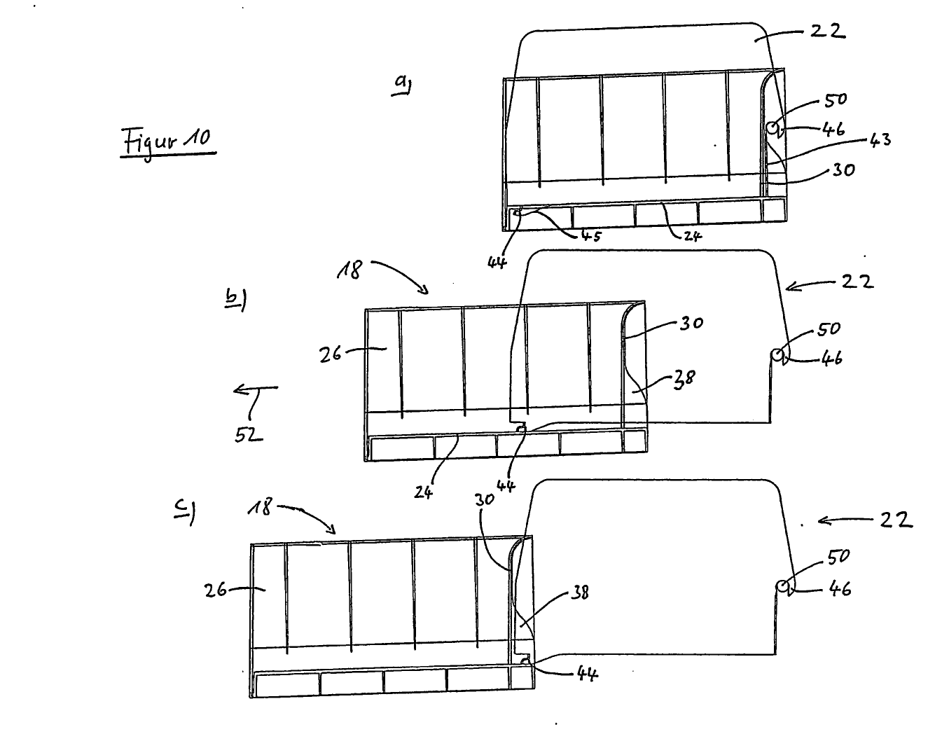

FIG. 9 a detail of the pull-out drawer of the embodiment shown in FIG. 7;

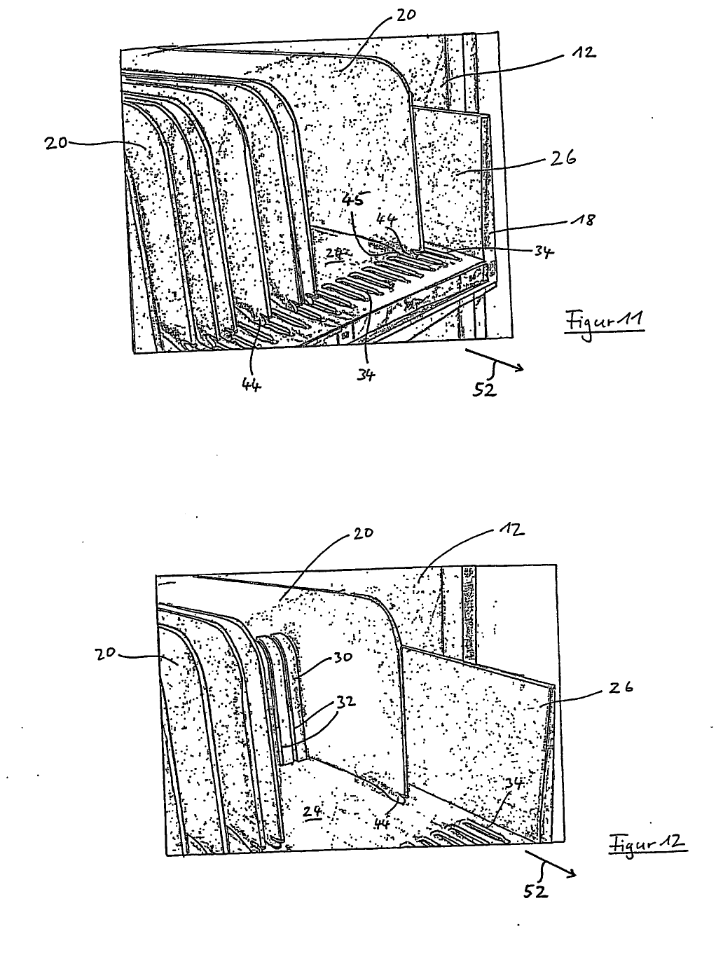

FIGS. 10a to 10c the movement procedure on the pulling out of the pull-out drawer of an embodiment in accordance with the invention;

FIG. 11 a detailed view during the pulling out of the pull-out drawer of the embodiment shown in FIG. 7;

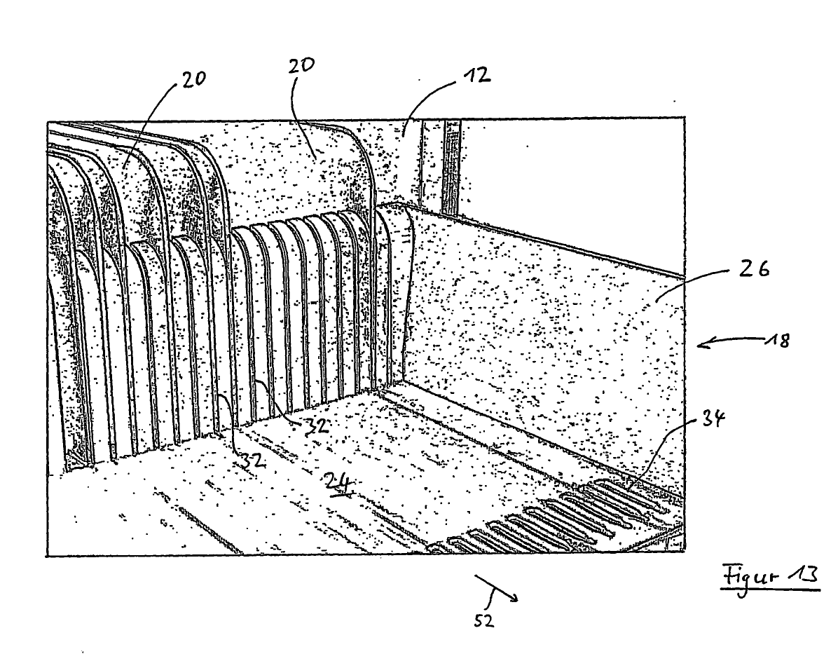

FIG. 12 a detailed view during the pulling out at a later time;

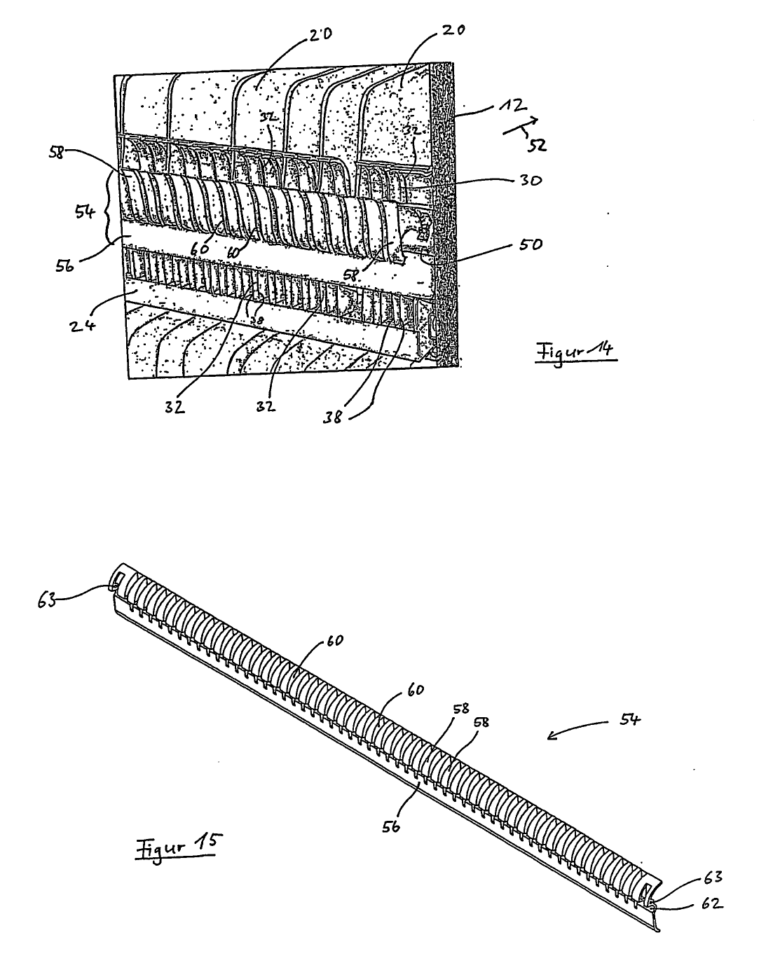

FIG. 13 a detailed view with a pulled-out pull-out drawer;

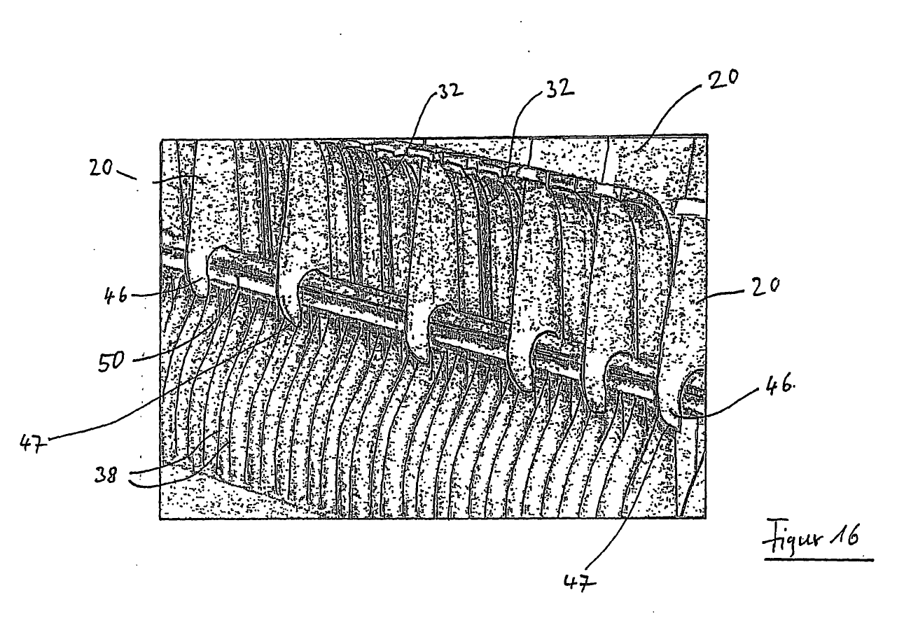

FIG. 14 a view of a sorting installation in accordance with the invention from the rear without a rear wall;

FIG. 15 a support of an embodiment in accordance with the invention;

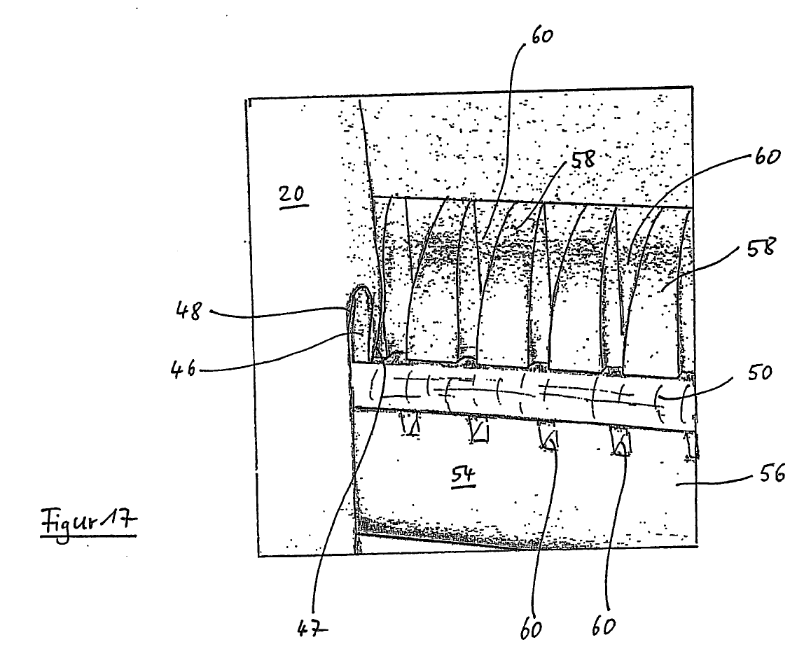

FIG. 16 a view from the rear of a detail of a sorting plant in accordance with the invention with a removed support;

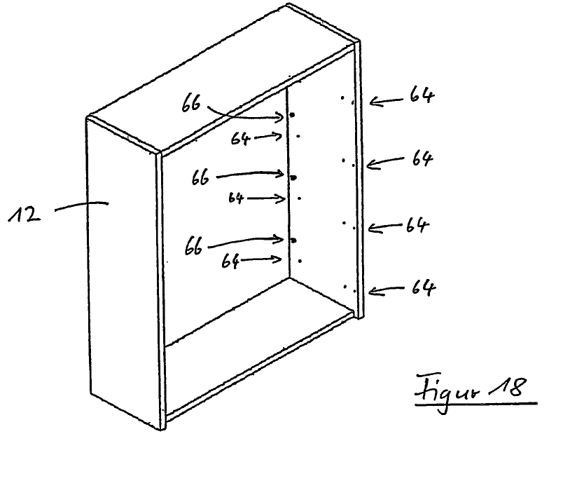

FIG. 17 a view from the front into a sorting compartment of a sorting installation in accordance with the invention in the region of the support with the pull-out drawer omitted; and

FIG. 18 a perspective view of a holder of an embodiment in accordance with the invention.

Elements of the same kind are as a rule provided with the same reference numerals in the Figures. If a plurality of similar elements can be recognized in a Figure, they are not all necessarily marked by respective reference numerals.

A sorting installation 10 in accordance with the invention is shown in FIG. 1. It has a holder 12 made as a carcass in which a plurality of sorting compartments 14, 16 are located. In the aspect shown, the second sorting compartment 14 is designed in accordance with the invention from below. It has a pull-out drawer 18 which is shown in the pulled-out state in FIG. 1. It moves on telescopic rails, not shown, on being pulled out. The sorting compartment 14 designed in accordance with the invention with the pull-out drawer 18 has separators 20. The details and the function of the separators 20 and of the pull-out drawer 18 of the sorting compartment 14 are explained in detail further below.

The sorting installation 10, which is shown in FIG. 1, has further compartments 16 which are arranged on shelf bases 17, but do not have a pull-out drawer. These remaining compartments 16 will therefore not be shown in detail.

The total sorting installation 10 is supported on a table 23 in the embodiment of FIG. 1 shown.

In a manner still to be described, the items of mail are located in the pull-out drawer 18 in each sorting step and thus lie on the base of the pull-out drawer 18. No shelf board such as is required in the form of the shelf boards 17 in the remaining sorting compartments 16 not designed in accordance with the invention is therefore necessary beneath the sorting compartment designed in accordance with the invention.

FIG. 2 shows a view of a pull-out drawer 18 obliquely from the front. It includes a base 24, side walls 26 and, in this embodiment, a stationary center wall 28. A rear wall 30 has a plurality of slots of which three are provided by way of example with the reference numeral 32. Projection mounts 34 in the form of openings are provided in the base 24 of the pull-out drawer in the region at the front in the pulling-out direction 52. The spacing of the projection mounts 34 from the rear wall 30 is marked by the reference numeral 35. A pull-out handle 36 is provided at the lower side of the pull-out drawer 18 at the front in the pulling out direction 52. The pull-out drawer is open toward the front. The desired stability can be achieved by skilful shaping and by struts in the base 24 of the pull-out drawer 18.

FIG. 3 shows the same pull-out drawer obliquely from the rear. It can in particular be recognized here that the slots 32 in the rear wall 30 have laterally bounding guide stubs 38 which stabilize the rear wall 30 and increase its effective thickness.

FIG. 4 shows a detailed view of the pull-out drawer 18 with inserted separators. Three separators 20, 21 are shown by way of example, with different shapes being selected which satisfy different demands. The shape of the separator 21 thus simplifies the access to items of mail, for example, in a sub-compartment formed by two adjacent separators, whereas separator 20 has a higher stability.

The separators have projections in the front lower region which are not visible in FIG. 4. FIG. 5, for example, shows the shape of the projection 44 for a separator 20. The separators 21 also have corresponding projections. The projections 44 engage into the projection mounts 34 and are hooked there. The rear edge of the separator projects through a slot 32 in the rear wall 30 of the pull-out drawer 18. The spacing 35 of the projection mounts 34 from the rear wall 30 is less than the spacing 49 of a projection 44 from the rear edge 43 of the separator (FIGS. 5 and 6). It is ensured in this manner that the separator is secured against tilting an lateral slipping in the pull-out drawer.

FIGS. 5 and 6 show two exemplary embodiments for separators 20 and 22. Whereas the separator 20 is rounded in the front region, the separator 22 is chamfered in the front region.

It can be recognized that the downwardly facing projection 44 includes a nose-like prolongation facing to the front. The edge 45 of the projection 44 at the rear in the pulling-out direction 52 of the pull-out drawer 18 is chamfered. The spacing of the projection 44 from the rear edge 43 of the separator is marked by the reference numeral 49.

A hook 46 is located at the rear edge of the separator 20, 22 and has a downwardly opening hook opening 48 whose outer side 47 is rounded.

The thickness of the embodiments of the separators shown taper upwardly.

FIG. 7 shows a view from the front into the sorting compartment 14 with a pull-out drawer 18 pushed into the holder 12. Separators 20 are held in a manner still to be described in the pull-out drawer in the projection mounts 34 and in the slots 32 of the rear wall 30.

FIG. 8 shows a detail of FIG. 7. It can in particular be recognized here that the projection mounts 34 are narrower in the region 40 disposed at the front in the pulling-out direction 52, with the dimensions being selected such that an inserted separator is held tight in the narrow region 40.

Designations 42 can be attached to the end face of the base 24 of the pull-out drawer which, for example, designate the delivery areas or individual post-office customers in the delivery areas.

FIG. 9 shows another view of a pull-out drawer 18 with separators 20 whose projections engage into the projection mounts 34. The pull-out drawer 18 has been pulled out a small amount in the pulling-out direction 52 here which corresponds approximately to the extent of the nose of a projection 44. The projections 44 are admittedly still plugged into the projection mounts 34, but their nose-shaped prolongations are no longer hooked in the narrow region 40 of the projection mounts. For this purpose, the dimension of the projection mounts 34 are selected accordingly.

FIGS. 10a to 10c show, in a schematic representation, how the pull-out drawer 18 and a separator 22 behave during the pulling-out process of the pull-out drawer 18. In a manner still to be described, the hook 46 of the separator 22 is hooked to a spatially fixed holding rod 50. The side wall 26 disposed at the front in the Figure is shown transparent here for better understanding so that the separator 22 is visible.

FIG. 10a shows the state with a pushed-in pull-out drawer 18. FIG. 10b shows the state with a pull-out drawer 18 half pulled out in the pulling-out direction 52. Whereas, in the position of FIG. 10a, the projection 44 of the separator 22 shown projects through the projection mount 34 in the base 24 of the pull-out drawer 18, it is disposed, in the half-pulled out state of FIG. 10b, on the base 24 of the pull-out drawer 18. The separator 22 is therefore slightly slanted.

The state with a completely pulled-out pull-out drawer 18 is shown in FIG. 10c. The separator 22 no longer projects through the rear wall 30 of the pull-out drawer 18 into its inner region so that the pull-out drawer 18 is no longer divided by the separator 22. The separator 22 is held in its spatial alignment against lateral tilting or sliding by the guide supports 38 of the rear wall 30.

FIGS. 11 to 13 show the pulling-out press shown in FIG. 10 starting from the state of FIG. 7 in a different perspective. The state shown in FIG. 7 in particular corresponds to FIG. 10a, whereas FIG. 12 corresponds to FIG. 10b and FIG. 13 to FIG. 10c. In addition, FIG. 11 shows the state between the states shown in FIGS. 10a and 10b in which the pull-out drawer 18 has already been pulled out so far that the projection 44 slides out of the projection mount 34.

FIG. 14 shows a view of the sorting plant from the rear, with the rear wall of the holder 12 having been removed. The state is shown with a pushed-in pull-out drawer 18 and with separators 20 which are held in slots 32 of the rear wall 30 of the pull-out drawer. It can be recognized how the rear regions of the separators 20 project through the slots 32 of the rear wall 30. A support 54, which has a support carrier 56, is provided in the region of the holding rod 50. Support prolongations 58, between which support mounts in the form of slots 60 are located, are provided at this support carrier. The support prolongations 58 are disposed on the holding rod 50 firmly mounted in the holder. The hooks 46 of the separators 20 project into the slots 60, with the hook openings 48 engaging around the holding rod 50 as can be recognized, for example, in FIGS. 10a to 10c. The lower region of the rear wall 30 and the base 24 of the pull-out drawer 18 are visible from the rear beneath the support 54. The guide stubs 38, which surround the slots 35 of the rear wall 30 in the lower region, can in particular also be recognized.

FIG. 15 shows an embodiment of a support 54. Whereas FIG. 14 shows the support 54 from the rear, the embodiment of FIG. 15 is shown obliquely from the front. The support mount 62 can in particular be seen here with which the support 54 is disposed at the holding rod 50. Reference numeral 63 designates screw bores in which, for example, adjustment screws can be provided to adjust the lateral position of the support 54 on the holding rod 50. For this purpose, corresponding adjustment screws are inserted into the screw bores 63 with whose help the support can, for example, be pushed and adjusted with respect to the side walls of the holder. The support is thus adjusted such that the slots 60 of the support 54 correspond to the slots 32 in the pull-out drawer 18.

FIG. 16 shows a view of the sorting installation from the rear. The support 54 has been removed here so that the cooperation of the hooks 46 of the separators 20 with the holding rod 50 can be recognized. It can be recognized in this respect that the hooks 46 engage around the holding rod 50.

FIG. 17 shows a view from the front into the rear region of a sorting compartment made in accordance with the invention. The view is shown without a pull-out drawer so that the cooperation of the support 54, of the holding rod 50 and of the hook 46 of the separator 20 becomes clear. It can be recognized how the support prolongations 58 lie on the holding rod 50. A separator 20 is located just before the holding rod 50, that is in a state just before the hook 46 hooks into a slot 60 around the holding rod 50.

A holder of an embodiment is shown in FIG. 18 which is configured for four sorting compartments 14 designed in accordance with the invention and disposed above one another. Screw bores 64 each serve for the fastening of the telescopic rails of the respective pull-out drawer 18. Openings 66 serve for the reception of the holding rods 50 of the respective sorting compartments. The opening for the holding rod of the topmost sorting compartment is not visible.

Possible dimensions for the individual elements are set forth in the following which are, however, only to be understood as exemplary.

The carcass 12 can, for example, have a width of approximately 50 cm or 100 cm with a depth of 35 cm. A height of approximately 130 cm is, for example, possible for a holder which can receive four sorting compartments in accordance with the invention above one another, as is shown in FIG. 18.

The holding rods 50 made of steel, for example, have a diameter of 14 mm. The height of the respective holding rod 50 in the holder 12 is selected in each case such that it corresponds to the position of the respective cut-out 48 of the hook 46 of a separator in the corresponding pull-out drawer.

The support 54 can be produced from plastic.

The separators are formed, for example, by plastic plates of a length of approximately 35 cm and a height of approx. 21 cm. In the lower region, they have a thickness of 4 mm which tapers upwardly, as can also be recognized in FIGS. 5 and 6.

The pull-out drawer 18 likewise consists of plastic and has, for example, a volume of 3500 cm³.

The sorting installation in accordance with the invention is put together as follows: Holding rods 50 are inserted into the holding rod mounts 66 in a holder 12 such as is shown in FIG. 18. Telescopic rails, not shown, are mounted in the screw bores 64 and carry pull-out drawers 18 and permit a pulling out of the pull-out drawer to the front up to an abutment. In an embodiment in accordance with FIG. 1, a pull-out drawer 18 is only provided in the second sorting compartment 14 from the bottom.

A support 54 is mounted for each pull-out drawer 18 or for each holding rod 50, with the support mount 62 being placed onto the holding rod 50. The support 54 is supported in this respect, for example, against a rear wall of the holder 12 and can thus not slip off the holding rod 50. With the help of the adjustment mechanism not shown in the Figures and utilizing the screw bores 63 in the support 54 (FIG. 15), the lateral position of the support 54 is set such that the slots 60 of the support 54 correspond to the slots 32 in the rear wall 30 of the pull-out drawer 18. Tolerances of the telescopic rails carrying the pull-out drawer 18 are compensated in this manner. The adjustment screws which are inserted into the adjustment screw bores 63 of the support 54 can clamp the support 54 against the side walls of the holder 12, for example.

The user can proceed as follows in use: He first selects which spacing the separators 20, 21, 22 should have from one another. The spacing of the individual separators 20, 21, 22 is selected in this respect such that it approximately individually corresponds to the amount of mail of individual delivery areas such that the respective sub-compartment associated with a delivery area can receive the typical amount of mail of the corresponding delivery area between two separators. Different sub-compartments therefore have—in accordance with the typical amount of mail of the delivery areas associated with them—a different width and accordingly a different spacing of the separators bounding them. The user then carries out the first equipping of the pull-out drawer 18 with separators 20, 21, 22. The pull-out drawer 18 is pulled out to approximately 80% of the maximum extension for this purpose. The separators are inserted in accordance with the desired spacing, with the projections 44 being hooked into the selected projection mounts 34 and the rear edges of the separators being guided into the corresponding slots 32 of the rear wall 30 of the pull-out drawer 18. A state arises such as is shown in FIG. 4. The separators 20, 21, 22 are held tight by the projections 44 in the projection mounts 24 and by the slots 32. The pull-out drawer 18 is now pushed to the rear into the sorting compartment 14, with the separators 20, 21, 22 moving backwardly with the pull-out drawer 18. At the end of the push-in process, the rounded outer side 47 of the hooks 46 is incident onto the holding rod 50. The outer side 47 of the hook 46 slides off upwardly at the holding rod 50 until the hook opening 48 is disposed above the holding rod 50. The separator 20, 21, 22 then again falls downwardly such that the hook 46 engages around the holding rod 50 as can be recognized, for example, in FIG. 10 or in FIG. 16. The hook 46 of the separator 20, 21, 22 is now disposed in a slot 60 of the support 54 on the holding rod 50 such that a movement of the separator in the pulling-out direction 52 is no longer possible.

The sorting box 14 is thus equipped for the specific demands of the user. Sub-compartments are in particular formed whose width individually corresponds to the typical amount of mail of individual delivery areas. As a rule, a change in the position of the separators is no longer necessary since the typical amount of mail does not change. The separators can optionally, however, be removed again by hand in that the engagement between the hook 46 and the holding rod 50 is cancelled.

The mail can now be sorted in the state of the pushed-in pull-out drawer 18 with the mounted separators. Individual items of mail are placed into individual sub-compartments corresponding to the delivery areas. After the mail has been completely sorted into the individual sub-compartments, the pull-out drawer 18 is pulled out again at the pull-out handle 36 in the pulling-out direction 52 up to the abutment of the telescopic rail. The separators 20, 21, 22 remain hooked on the holding rod 50 and thus completely lose their function as dividing members up to the maximum extension of the pull-out drawer 18. This can be recognized in FIG. 10. Whereas the separators 22 shown there are hooked to the holding rod 50 in FIG. 10a and the pull-out drawer is still not yet pulled out, the pull-out drawer is pulled out in the pulling-out direction 52 in FIG. 10b, whereas the separators 22 remain hooked to the holding rod 50. FIG. 10c shows the state in which the pull-out drawer 18 is completely pulled out and the separators 22 no longer exert their dividing function in the pull-out drawer 18. The separators 22 are secured against falling over by the guide stubs 38 and by the rearwardly bent upper end of the rear wall 30.

The pull-out process is shown again in detail in the sequence of FIG. 9 and FIGS. 11 to 13 starting from the state of FIG. 7. The projection 44 is still in the projection mount 34 in FIG. 7. The pull-out drawer 18 has already been pulled out a little in FIG. 9 so that the nose-shaped prolongations of the projections 44 are no longer hooked in the projection mounts 34. FIG. 11 shows how, on a further pulling out of the pull-out drawer in the pulling-out direction 52, the sloped rear edge 45 of the projection 44 supports the sliding of the projection 44 of the separator 20 out of the projection mount 34 so that the separator moves slightly upwardly in the front region. FIG. 12 shows a state corresponding to FIG. 10b. FIG. 13 shows the pull-out drawer 18 in the completely pulled out state. It can be recognized that the separators 20 no longer extend into the pull-out drawer 18 such that the pull-out drawer 18 is now completely without any division (with the exception of an optionally provided center wall 28).

The user can now put his hand into the pull-out drawer and push the sorted mail together either against a side wall 26 or against the center wall 28 of the pull-out drawer 18. The total amount of mail associated with the pull-out drawer between a side wall and the center wall 28 can be removed in one step and placed into the mailbag, for example, in sorted form.

It is therefore not necessary to individually empty every single sub-compartment of the sorting compartment associated with a delivery area and to take over its content into the mailbag. The sorting process, in particular the removal process from the sorting compartment, is thus substantially simplified and a great deal shorter in time than with sorting compartments without a pull-out drawer.

After the removal, the pull-out drawer 18 is pushed back into the sorting compartment 14 again, with the separators 20, 21, 22 again adopting their dividing function and the projections 44 of the separators hooking in the projection mounts 34 in the base 24 of the pull-out drawer 18. The state arises again as is shown in FIG. 7, for example, in which the pull-out drawer 18 is divided into sub-compartments by the separators. The sorting installation is now ready for a further sorting process.

The sorting installation works mechanically and is therefore very cost-effective and robust.

### REFERENCE NUMERAL LIST

10 sorting installation
12 holder, carcass
14 sorting compartment
16 sorting compartment
17 shelf board
18 pull-out drawer
20, 21, 22 separators
23 table
24 base of the pull-out drawer
26 side wall
28 center wall
30 rear wall of the pull-out drawer
32 slots in the rear wall
34 projection mounts
35 spacing of the projection mounts from the rear wall of the pull-out drawer
36 pull-out handle
38 guide stubs
40 narrow region of the projection mounts
42 marking
43 rear edge of the separator
44 projection
45 chamfered edge of the projection
46 hook
47 rounded outer hook side
48 hook opening
49 spacing of a projection from the rear edge of a separator
50 holding rod
52 pulling-out direction
54 support
56 support carrier
58 support prolongation
60 slot
62 support mount
63 adjustment screw bore
64 screw bore
66 holding rod mount

1-15. (canceled)

16. A sorting installation (10) for the sorting of articles to be sorted, in particular items of mail, comprising
a holder (12) preferably made as a carcass and open to the front;
at least one sorting compartment (14, 16) in the holder (12) for the reception of sorted articles; and
at least one dividing member (20, 21, 22) for the division of the at least one sorting compartment into sub-compartments,
wherein
at least one sorting compartment (14) includes a pull-out drawer (18) which can be pulled out at least partly from the holder (12) in the pulling-out direction (52) and which preferably is open to the front;
at least one dividing member is made as a separator (20, 21, 22) which is arranged parallel to the pulling-out direction (52), which is not firmly connected to the pull-out drawer (18) and which does not move along in the pulling-out direction (52) on the moving out of the pull-out drawer (18) such that the pull-out drawer (18) is no longer divided by the at least one separator (20, 21, 22) after having been moved out, the at least one separator (20, 21, 22) has a hook (46) at its edge arranged at the rear in the pull-out drawer (18), the hook opening (48) of said hook preferably being directed downwardly;
a horizontal holding edge or holding rod (50) aligned parallel to the rear wall (30) of the pull-out drawer (18) is provided in the holder (12) and is arranged such that the hook (46) of the separator (20, 21, 22) can hook to it so that in the hooked in state the separator (20, 21, 22) cannot move in the pull-out direction (52) with the pull-out drawer (18); and
the hook (46) is rounded or chamfered at its outer side (47) and/or the holding rod or the holding edge is rounded or chamfered at the side facing the pull-out drawer (18) such that the hook (46) slides off the holding edge or holding rod (50) when the at least one separator (20, 21, 22) and the holding rod (50) or the holding edge move relative to one another until the hook opening (48) can engage around the holding rod (50) or the holding edge.

17. A sorting installation in accordance with claim 16, wherein the at least one pull-out drawer (18) includes, in the rear region, a plurality of guides, preferably by formation of a multiply slotted rear wall (30), with the individual guides or slots (32) being made such that a separator (20, 21, 22) can slide through them.

18. A sorting installation in accordance with claim 17, wherein the slots (32) in the rear wall (30) of the pull-out drawer (18) are dimensioned such that they can guide the at least one separator (20, 21, 22).

19. A sorting installation in accordance with claim 17, wherein the slots (32) of the rear wall (30) of the pull-out drawer (18) include guide stubs (38) which effectively increase the thickness of the rear wall 30) in the region of the slots. (32).

20. A sorting installation in accordance with claim 16, wherein the at least one separator (20, 21, 22) can be removed.

21. A sorting installation in accordance with claim 16, comprising a support (54) having at least one support mount (60), preferably of a slot type, for the at least one separator, with the support (54) being stationary with respect to the holder (12) and the at least one support mount (60) being made such that it holds the at least one separator (20, 21, 22) in its spatial orientation on the pulling-out movement of the pull-out drawer (18).

22. A sorting installation in accordance with claim 21, wherein the support (54) has an adjustment mechanism which is made to adjust the at least one support holder (60) such that, in this manner, the spatial alignment and/or the spatial position of the separator (20, 21, 22) supported by it is adopted.

23. A sorting installation in accordance with claim 16, wherein the at least one separator (20, 21, 22) has a projection (44) which cooperates with a corresponding projection mount (34) in the pull-out drawer (18) such that the projection (44) is held in the projection mount (34) in the pushed-in state of the pull-out drawer (18) and is released from the projection mount (34) on the moving out of the pull-out drawer (18).

24. A sorting installation in accordance with claim 23, wherein the projection (44) of the at least one separator (20, 21, 22) is provided in the region of the separator (20, 21, 22) at the front in the pulling-out direction (52) of the pull-out drawer (18), preferably at its lower edge.

25. A sorting installation in accordance with claim 24, wherein the projection (44) of the at least one separator (20, 21, 22) and/or the corresponding projection mount is/are chamfered or rounded such that they slide off one another on the pulling out of the pull-out drawer (18).

26. A sorting installation in accordance with claim 23, wherein the spacing (49) of the projection (44) of the at least one separator (20, 21, 22) from the edge (43) of the separator (20, 21, 22) disposed at the rear in the pulling-out direction (52) of the pull-out drawer (18) is larger than the spacing (35) of the projection mount (34) from the rear wall (30) of the pull-out drawer (18) such that the at least one separator (20, 21, 22) projects through an opening or a slot (32) in the rear wall (30) of the pull-out drawer (18).

27. A sorting installation in accordance with claim 16, wherein the at least one separator (3, 20, 21) is made as an injection molded plastic part.

28. A mail sorting apparatus for the sorting of items of mail, in particular letters, using a sorting installation in accordance with claim 16.

29. A sorting installation in accordance with claim 18, wherein the slots (32) of the rear wall (30) of the pull-out drawer (18) include guide stubs (38) which effectively increase the thickness of the rear wall 30) in the region of the slots. (32).

30. A sorting installation in accordance with claim 29, wherein the at least one separator (20, 21, 22) can be removed.

31. A sorting installation in accordance with claim 17, wherein the at least one separator (20, 21, 22) can be removed.

32. A sorting installation in accordance with claim 18, wherein the at least one separator (20, 21, 22) can be removed.

33. A sorting installation in accordance with claim 19, wherein the at least one separator (20, 21, 22) can be removed.

34. A sorting installation in accordance with claim 33, comprising a support (54) having at least one support mount (60), preferably of a slot type, for the at least one separator, with the support (54) being stationary with respect to the holder (12) and the at least one support mount (60) being made such that it holds the at least one separator (20, 21, 22) in its spatial orientation on the pulling-out movement of the pull-out drawer (18).

35. A sorting installation in accordance with claim 32, comprising a support (54) having at least one support mount (60), preferably of a slot type, for the at least one separator, with the support (54) being stationary with respect to the holder (12) and the at least one support mount (60) being made such that it holds the at least one separator (20, 21, 22) in its spatial orientation on the pulling-out movement of the pull-out drawer (18).
